(19) United States
(12) Patent Application Publication
(10) Pub. No.: US 2005/0139603 A1
(43) Pub. Date: Jun. 30, 2005

(54) INTRA-PACKAGING STRAW FOR LAMINATED PAPERBOARD-BASED LIQUID CONTAINERS

(76) Inventor: Han-Pin Lee, TAICHUNG (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,311

(22) Filed: Jan. 8, 2003

(51) Int. Cl. A61J 15/00

(52) U.S. Cl. 220/705; 239/33; 220/709; 220/708

(57) ABSTRACT

A liquid container with intra-packaging straw comprises a liquid container into which a straw support is attached. The straw support comprises a support pad that is attached to and covers an opening of the liquid container, and a straw that is placed through the support pad and oppositely extends in and out of the liquid container to allow drinking. The straw insertion is hermetically isolated via directly sealing the straw to the support pad or attaching a flexible film respectively to the straw and the support pad. The support pad may be further hollow so that the straw folded by means of an elbow portion can be contained within the hollow support pad.

### BACKGROUND OF THE INVENTION

1. Field of the Invention

The invention relates generally to a liquid container and, more particularly, to a liquid container provided with an incorporated straw element.

2. Description of the Related Art

Liquid containers presently appear under many various types and forms. For example, well known Tetra-Brik® paperboard-made liquid containers are easily distinguished on the shelves of alimentary shops. To facilitate the drinking, a Tetra-Brik® liquid container may be additionally provided with a straw that is externally adhered onto the container. However, the external provision of a straw may result in various inconveniences. For example, when several liquid containers are packed together and transported, the straws may be separated from their respective containers and be definitely lost. Furthermore, dust and any other types of contaminant particles may deposit on the aluminum foil that seals the straw hole formed through the liquid container. Therefore, when the straw is punched through the aluminum foil into the container, the contained liquid is adversely contaminated. In other situations, the straw, too short, may simply drop within the interior of the liquid container.

A well known type of liquid container is that of gable-top container. A gable-top container is usually not provided with an external straw. This container usually has a top seal or fin that is hermetically sealed. To drink the liquid contained in a gable-top container, the user usually has to oppositely pull out the hermetically sealed panels of the top seal or fin until the opening of the container is exposed and, then, adjust an adequate shape of the opening to drink the liquid. When the liquid is drunk directly through the hence-formed opening, leakage may occur between the opening of the container and the user's mouth. Moreover, drinking through the opening of the gable-top container inconveniently necessitates inclining the head, which may be dangerous in certain situations such as while driving a car, for example.

Some liquid containers such as Tetra Rex® packages may also be provided with a specifically arranged pouring hole or pouring tube closed by a cap. This type of arrangement can provide an adequate use when the liquid is poured out, but is less convenient if the liquid is directly drunk through the pouring tube due to its relative large size, and a separate straw is thus still needed. Moreover, the mount of the pouring tube requires an additional operation of forming a hole through the package wall.

### SUMMARY OF THE INVENTION

An aspect of the invention is therefore to provide a liquid container with an intra-packaging straw that allows a user to drink the liquid enclosed directly from the liquid container without the need of a separate straw.

Another aspect of the invention is to provide a liquid container with an intra-packaging straw that allows a user to drink the liquid enclosed either directly from the liquid container without the need of a separate straw, or via conveniently pouring the liquid into an external recipient.

To accomplish the above and other objectives, a liquid container with intra-packaging straw comprises a liquid container in which a straw support is attached. The straw support comprises a support pad that is attached in an opening of the liquid container, and a straw that is placed through the support pad and oppositely extends inside and outside the liquid container. A hermetic isolation of the portion of the straw inserted through the support pad is accomplished through various methods. One method is to directly seal the straw to the support pad at the inserted portion of the straw. Another method is to enclose a volume including an opening of the support pad where the straw is placed and a straw portion over the support pad by means of a flexible film respectively sealed to the straw and the support pad. With the flexible film, the straw can be freely moved through the support pad. Within the volume enclosed by the flexible film, if a lateral side of the straw is further provided with a groove, the flexible film and the straw form a funnel structure that enables the enclosed liquid to be poured out. To allow the enclosed liquid to be poured out, a tube may be alternatively placed through the support pad additional to the straw. The length of the tube that extends in the liquid container is as short as possible to pour out the entire enclosed liquid. Furthermore, the straw may be provided with an elbow placed on a straw portion that can be either within the liquid container or outside the liquid container.

The straw support of the invention can accommodate various types of laminated paperboard-based liquid containers to form a liquid container with an intra-packaging straw, including, but not limited to, a gable-top type liquid container and a flat-top type liquid container. With the straw support of the invention directly mounted in the existing opening of the package, no additional hole is needed such as in traditional Tetra Brik® packages or Tetra Rex® packages.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A through FIG. 1D are various perspective views illustrating various examples of a liquid container with an intra-packaging straw according to a first embodiment of the invention;

FIG. 2A through FIG. 2E are various perspective views illustrating various examples of a liquid container with an intra-packaging straw according to a second embodiment of the invention; and

FIG. 3A through FIG. 3D are various perspective views illustrating various examples of a liquid container with an intra-packaging straw according to a third embodiment of the invention.

### DETAILED DESCRIPTION OF THE PREFERRED EMBODIMENTS

The following detailed description of the embodiments and examples of the present invention with reference to the accompanying drawings is only illustrative and not limiting. Wherever possible in the following description and accompanying drawings, like reference numerals and symbols will refer to like elements and parts unless otherwise described.

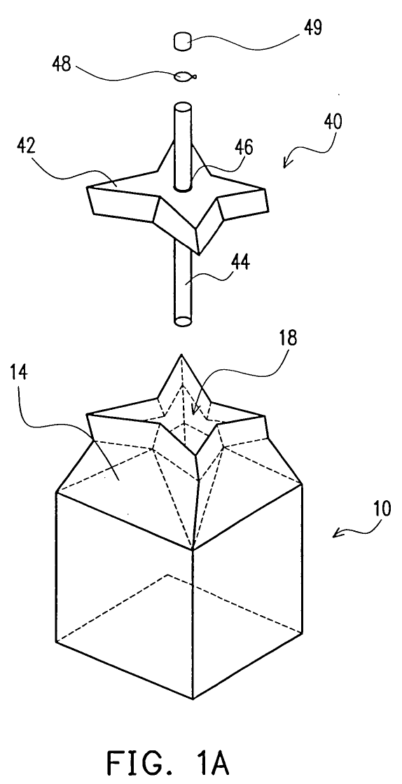

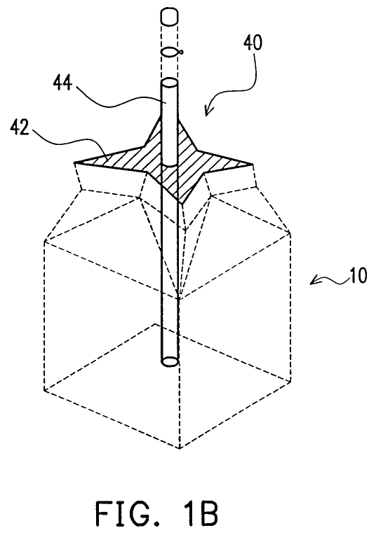

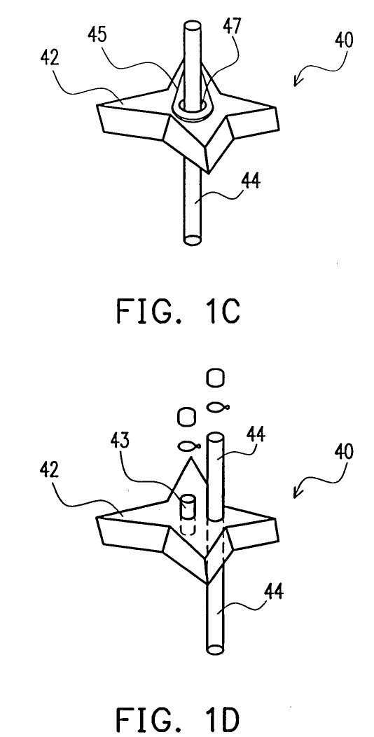

Referring now to FIG. 1A, a perspective view schematically illustrates a liquid container of gable-top type that is provided with a straw support according to a first embodiment of the invention. As shown in FIG. 1A, the invention provides a straw support 40 that is arranged on a liquid container 10. The liquid container 10, preferably made of laminated paperboard-based material, has an upper portion 14 on the top of which an opening 18 is defined.

The straw support 40 comprises a support pad 42 through which a straw 44 is tightly inserted. Via a sealed portion 46, the straw 44 is sealed to the support pad 42. The straw 44 further oppositely extends over the support pad 42 and inside the liquid container 10. The support pad 42 and the straw 44 can be made of various types of material such as plastics, for example. The support pad 42 is designed in a manner to tightly engage in the opening 18 and be hermetically sealed to the rim of the opening 18, preferably to the inner surface of the rim of the opening 18, via known methods such as heat sealing, ultrasonic welding or adhesive bonding.

As shown in FIG. 1A, the shape of the opening 18 can be defined from, for example, a folding pattern of the upper portion 14. FIG. 1A illustrates an example of folding pattern that is usually implemented to seal parallelepiped containers according to a gable-top manner. The shape of the support pad 42 should be consequently adapted to the shape of the opening 18, which is usually a star shape with four branches. In this example, the shape of the support pad 42 is preferably fitted to the star-shaped opening 18 because it favorably has a reduced size due to the folding pattern. As a result, the support pad 42 can be made with a relatively small size that easily accommodates the traditional liquid container 10 without substantially changing its manufacturing process. After the folding pattern of the upper portion 14 is achieved, the straw support 40 is arranged in the opening 18 with a lower portion of the straw 44 lying in the liquid container 10, and the rim of the opening 18 is hermetically adhered to the support pad 42. As shown in FIG. 1B, a structure of liquid container with an intra-packaging straw is therefore achieved. To allow drinking of the entire amount of liquid enclosed in the container 10, the length of the straw 44 approximately reaches the bottom of the container 10. A seal 48 and a covering 49 are further disposed on the externally exposed opening of the straw 44 to prevent contaminant penetration into the liquid container 10 and liquid leakage before consumption. In another example not illustrated, the upper portion 14 may not be folded and is instead fully open in a rectangular shape, in which case the support pad 42 will be consequently also approximately rectangular.

Referring to FIG. 1C, a perspective view schematically shows a variant example of the above first embodiment. In the previous first embodiment, the straw 44 is tightly inserted and sealed through the support pad 42. Therefore, the user cannot move the upper portion of the straw 44 to adjust the position of the straw 44 within the liquid container. As shown in FIG. 1C, a relative move of the straw 44 through the support pad 42 may be allowed via forming an opening 47, where the straw 44 is inserted through the support pad 42, that is larger than the diameter of the straw 44. The straw 44 thus is not sealed to the support pad 42. Instead, a flexible film 45, for example a plastic film or a laminated aluminum foil, is respectively sealed to the support pad 42 and an upper portion of the straw 44 that is over the support pad 42. A volume including the opening 47 and a straw portion over the opening 47 is thereby enclosed and hermetically isolated from the exterior by means of the flexible film 45. The flexible film 45 hence prevents contaminant penetration into the liquid container 10 meanwhile enabling a relatively free move of the straw 44 through the opening 47. As a result, the user can favorably adjust the inclination angle or length of the straw 44 over the support pad 42.

Referring to FIG. 1D, a perspective view schematically illustrates another variant example of the first embodiment of the invention. In the first embodiment, the straw 44 is inserted through the support pad 42 to enable the user to suck out the liquid enclosed the liquid container 10. As shown in FIG. 1D, in addition to the straw 44, a tube 43 may be further inserted through the support pad 42. The length of the tube 43 extending in the liquid container 10 should be as short as possible to allow the entire amount of enclosed liquid to be poured out. In an example, the tube 43 may be placed in a manner to have an end portion thereof extending slightly over an inner surface of the support pad 42. Furthermore, the tube 43 is spaced away from the straw 44 in such a manner that, via an adequate inclination of the liquid container 10, the liquid of the container 10 can flow out through the tube 43. As a result, the tube 43 can be used as a pouring tube through which the enclosed liquid can be poured into an external recipient. Before consumption, a seal and a covering close the tube 43. The above arrangement may be particularly convenient for liquid container of larger size that can serve several persons.

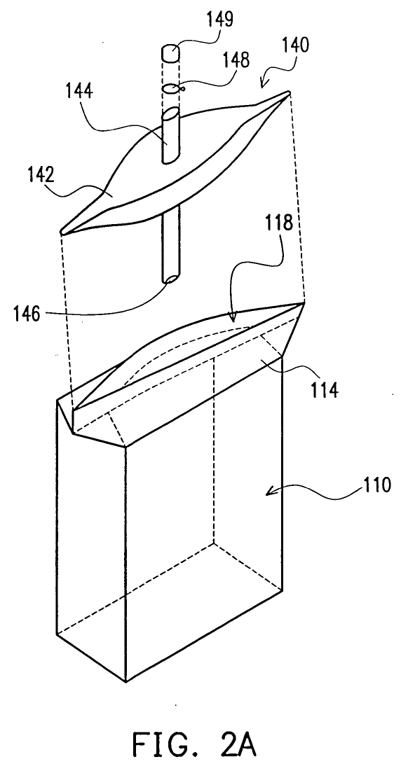

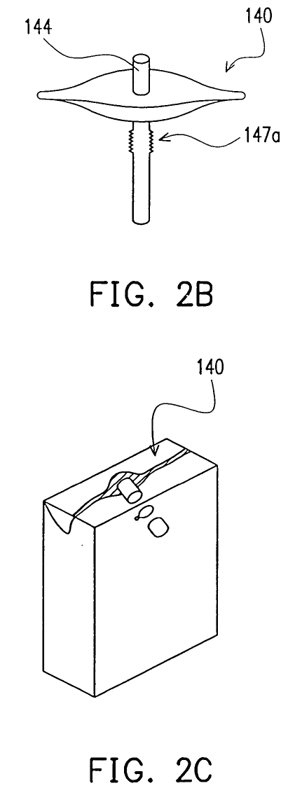

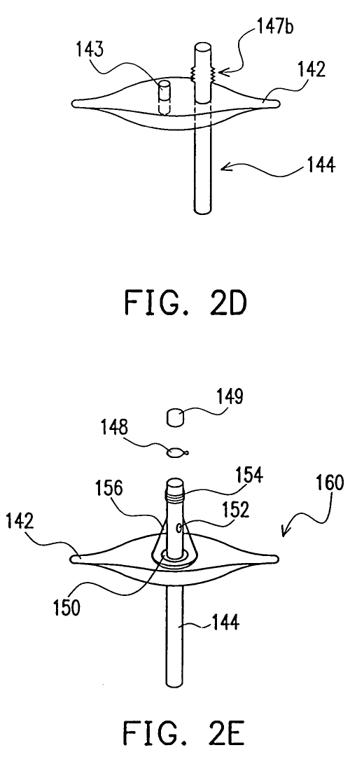

Referring now to FIG. 2A, a perspective view schematically illustrates a liquid container of flat-top type that is provided with a straw support according to a second embodiment of the invention. A liquid container 110 of flat-top type usually has a top portion 114 folded into a specific folding pattern that enables the finally folded and sealed liquid container 110 to have a flat top (FIG. 2A illustrates the top portion 114 unfolded and opened). As a result, several flat-top type liquid containers can be conveniently packed onto one another. As illustrated in FIG. 2A, the top portion 114 includes an opening 118 that, partially unfolded, approximately extends lengthwise.

Similar to the previous first embodiment, a straw support 140 comprises a support pad 142 and a straw 144 inserted through the support pad 142. The straw 144 is sealed to the support pad 142, and a groove 146 may be additionally defined on the rim of a lower end opening of the straw 144 to enlarge this lower end opening and facilitate liquid passage. To fit the opening 118, the support pad 142 is accordingly lengthwise shaped with a larger central portion holding the straw 144 and narrower opposite end portions. Once the straw support 140 is attached and hermetically sealed to the opening 118, the length of the straw 144 approximately reaches the bottom of the liquid container 110. A seal 148 and a covering 149 further respectively close an external opening of the straw 144 over the support pad 142. If the top portion 114 is entirely unfolded, the opening 118 consequently has a rectangular shape, and the support pad 142 will be accordingly formed with a rectangular shape.

As illustrated in FIG. 2B, in order to facilitate the packing of the container 110 with other containers, the straw 144 may be further provided with an elbow 147a. As shown in FIG. 2C, once the straw support 140 is attached and sealed into the opening 118, the upper portion of the straw 144 is thereby bent sideways. The stack of another container on the top of the container 110 can be therefore facilitated. As shown in FIG. 2D, in order to bend sideways the upper portion of the straw 144, an elbow 147b placed above the support pad 142 may also favorably substitute for the elbow 147a placed below the support pad 142.

Referring to FIG. 2D, a perspective view schematically illustrates a variant example of the above second embodiment. In addition to the straw 144, a tube 143 may be additionally inserted through the support pad 142 to allow the user to pour out the liquid in the liquid container, similar to the arrangement illustrated in FIG. 1D.

Referring to FIG. 2E, a perspective view schematically illustrates another variant example of the straw support according to the second embodiment of the invention. In FIG. 2E, a straw support 160 comprises a support pad 142 having an opening 150 through which a straw 144, of smaller diameter, is inserted. The straw 144 is closed via a seal 148 and a cap 149 that engages a threaded portion 154 of the straw 144. A flexible film 156, for example a plastic film or a laminated aluminum foil, is further respectively sealed to the support pad 142 and an upper portion of the straw 144 over the opening 150. A volume including the opening 150 and a straw portion over the opening 150 is thereby enclosed and hermetically isolated from the exterior by means of the flexible film 156. With the above arrangement, the straw 144 can be freely moved while the flexible film 156 prevents contaminant penetration through the opening 150 into the liquid container.

Additionally, a groove 152 is defined through the lateral side of the straw 144. The groove 152 is formed at a level of the straw 144 that is enclosed within the flexible film 156.

The above straw support 160 is attached into the opening 118 of the liquid container 110 in a manner similar to the illustration of FIG. 2A to achieve a liquid container with an intra-packaging straw.

To suck out the liquid enclosed in the liquid container, the user first removes the cap 149 and the seal 148. With one user's finger pressing the flexible film 156 to obstruct the groove 152, the liquid can be sucked out through the straw 144.

To pour out the liquid enclosed in the liquid container, the user inclines the liquid container in a manner to have the external end opening of the straw 144 substantially oriented downward. The liquid flows out through the opening 150 into the volume enclosed by the flexible film 156 and, via the groove 152, finally flows out through the external opening of the straw 144. The flexible film 156 and straw 144 act as a funnel to enable the liquid to flow out through the straw 144.

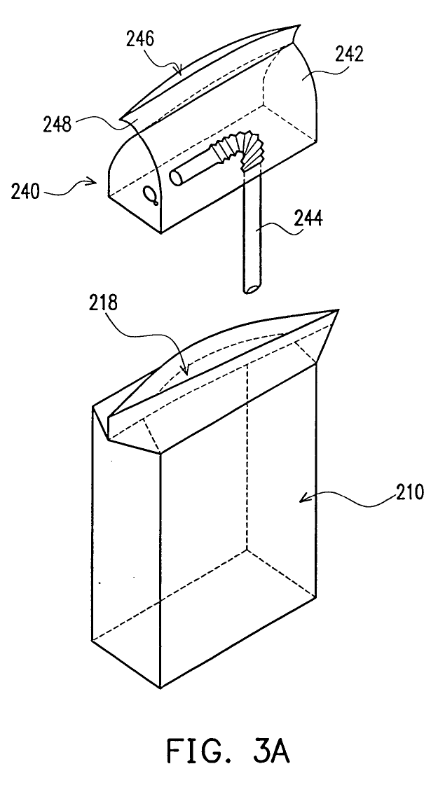

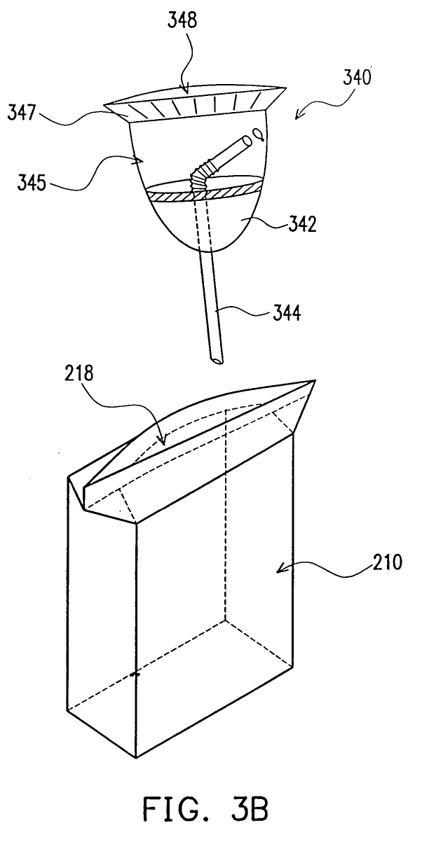

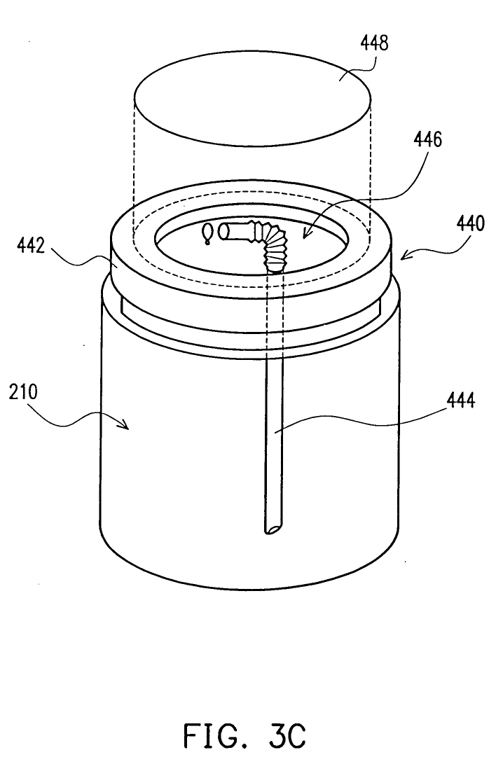

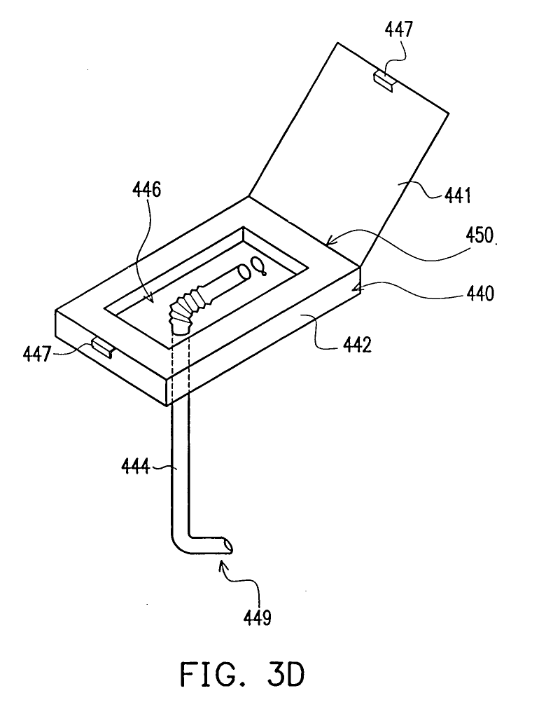

The above description illustrates various embodiments and examples of liquid containers with an intra-packaging straw that enable convenient drinking of the liquid container via the incorporated straw member. However, these examples of liquid containers include a straw member that protrudes externally over the liquid container. One may desire a straw member that is incorporated in the liquid container in a foldable manner so that the straw member can be either folded and entirely placed within the liquid container or unfolded and outwardly protrude over the liquid container to allow drinking. The folding of the straw member entirely within the liquid container is particularly advantageous when the liquid container has to be packed with other similar liquid containers because it enables a compact arrangement of the external envelope of the liquid container. Compact disposition of several liquid containers of the above type, for example by stacking, is thereby greatly facilitated. In consideration of the above purposes, reference now is made to FIG. 3A through FIG. 3D that illustrate various perspective views of a liquid container with an intra-packaging straw arranged according to a third embodiment of the invention.

In FIG. 3A, a first example of the invention is constructed from a hollow straw support 240 that comprises a lower hollow portion 242 communicating only with an upper collar 248 that is externally opened via an opening 246. A straw 244 having an elbow portion passes through and hermetically adheres to a bottom surface of the lower hollow portion 242 in a manner to upwardly lie within the cavity defined in the lower hollow portion 242. Therefore, an upper portion of the straw 244 including the elbow portion lies within the lower hollow portion 242 of the straw support 240 while a lower portion of the straw 244 downwardly extends into the liquid container. The hollow straw support 240 may be made of any adequate flexible materials such as plastics that allow easy shaping and manufacture. The opening of the straw 244 within the straw support 240 is further hermetically closed with a seal.

The above straw support 240 is mounted to a liquid container 210, provided with an opening 218, by adhering external surfaces of the collar 248 to the sidewalls of the opening 218 while the lower hollow portion 242 with the straw 244 therein is located within the liquid container 210. The opening 246 of the collar 248 is not sealed. The liquid container 210 may be any types of liquid containers such as flat-top type, for example.

When the liquid container is not open, the collar 248, hermetically adhered to the rim of the opening 218, may be folded in a manner similar to traditional flat-top liquid containers, thereby facilitating a disposition of the liquid container. To open and drink the liquid container, the user erects the collar 248 and presses on two opposite sides of the collar 248 to enlarge its opening 246. The user then unfolds the straw 244 that consequently protrudes upward over the opening 246, and removes the seal of the straw 244. The liquid enclosed in the liquid container 210 then is ready to be drunk by suction through the straw 244.

Referring to FIG. 3B, a perspective view illustrates a variant example of the liquid container with an intra-packaging straw according to the third embodiment of the invention. In this example, the straw support 340 is comprised of a support pad 342 that is, for example, hemispherical. Other shapes such as rectangular shapes may be also adequate. A flexible film 345 made of, for example, flexible plastics or laminated aluminum foil, is adhered to a rim of the hemispherical support pad 342. The flexible film 345 upwardly forms a collar 347 that is externally open via an opening 348 not sealed. The flexible film 345 and the hemispherical support pad 342 define an inner hollow volume in which a straw 344, provided with an elbow portion and inserted through the support pad 342, partially lies. The straw support 340 is mounted to the liquid container 210 by adhering the collar 347 to the rim of the opening 218 while the support pad 342, with a downwardly extending portion of the straw 344, freely lie within the liquid container 210. The liquid container 210 may be, for example, a flat-top type liquid container. It would be readily appreciated that because of the flexibility characteristic of the flexible film 345, other types of liquid containers such as circular containers or gable-top containers are also suitable. The above straw support 340 enables a relatively free move of the support pad 342 and thereto sealed straw 344 within the liquid container 210, the user thereby can rotate the straw 344 to an optimal position for drinking the enclosed liquid.

Referring to FIG. 3C and FIG. 3D, two perspective views illustrate other variant examples of the liquid container with an intra-packaging straw according to the third embodiment of the invention. In FIG. 3C, a straw support 440 is comprised of a support pad 442 made of, for example, rigid plastics. A recessed cavity 446 is defined at an upper side of the support pad 442 and a straw 444, provided with an elbow portion, passes through the support pad 442 via its recessed cavity 446. The height of the recessed cavity 446 should be sufficient to cover the height of the straw 444 folded by means of the elbow portion. The opening of the straw 444 is further hermetically closed with a seal. A covering 448 upwardly seals the recessed cavity 446 by covering the folded straw 444. The above straw support 440 is mounted to the liquid container 210 via adhesion to the rim of the opening of the liquid container 210. To drink the enclosed liquid, the user removes the covering 448 and unfolds the straw 444. By removing the seal of the straw opening, the liquid then can be drunk. With the above disposition, the top of the liquid container 210 is substantially flat so as to facilitate its disposition with other liquid containers.

FIG. 3D shows a variant example of the above structure where the covering may be replaced with a cover 441 that is provided with latches 447 and is connected to the support pad 442. By for example compression molding method, the cover 441 is integrally formed with the support pad 442 and connected via a hinge 450. The cover 441 closes and covers the recessed cavity 446 by engagement of the latches 447. The straw 444 may additionally include a L-shaped end 449 that reaches the bottom of the container to facilitate drinking of liquid remaining on the bottom of the liquid container 210.

As described above, the invention therefore provides various structures of a liquid container with intra-packaging straw that incorporates a straw support therein. Thereby, the user can conveniently suck out the liquid enclosed in the liquid container directly through the provided straw, and no separate straw is needed. The cumbersome opening operation and inconvenient drinking of traditional liquid containers such as gable-top containers or flat-top containers are therefore favorably overcome with the invention. Furthermore, contaminant penetration into the liquid container caused by straw punching is eliminated. The invention can be practically implemented with any types of laminated paperboard-based liquid containers. To achieve the straw support, the invention discloses various examples of arrangement that do not limit the scope of the inventive concept of the straw support.

In one basic arrangement, the straw support includes a support pad that is adhered to an opening of the liquid container, and a straw that is hermetically inserted through the support pad in a manner to extend in the liquid container. The straw is hermetically placed through the support pad via direct sealing there between.

In another variant arrangement, a flexible film, enclosing a volume that includes the opening of the support pad where the straw is placed and a portion of the straw over the support pad, substitutes for the direct sealing. Thereby, the straw can be moved through the support pad. With a lateral side of the straw further provided with a groove, the flexible film can further achieve the function of a funnel to pour out the liquid through the straw.

In another variant arrangement, the invention provides a straw support that enables a compact arrangement of the upper portion of the straw within the liquid container so that the top of the liquid container can be arranged relatively flat, thereby facilitating its disposition.

It should be apparent to those skilled in the art that other structures that are obtained from various modifications and variations of various parts of the above-described structures of the invention would be possible without departing from the scope and spirit of the invention as illustrated herein. Therefore, the above description of embodiments and examples only illustrates specific ways of making and performing the invention that, consequently, should cover variations and modifications thereof, provided they fall within the inventive concepts as defined in the following claims.

1. A liquid container with an intra-packaging straw, comprising:
a liquid container for enclosing a liquid therein, the liquid container having a top portion where a first opening is defined; and
a straw support, hermetically attached to and covering the first opening of the liquid container, the straw support including a support pad and a straw that is hermetically placed through a second opening of the support pad in a manner to oppositely extend in the liquid container and over the straw support so as to allow drinking of the liquid via suction through the straw.

2. The liquid container of claim 1, wherein the straw includes an elbow portion.

3. The liquid container of claim 1, wherein the straw is hermetically arranged through the support pad via sealing the straw to a rim of the second opening of the support pad.

4. The liquid container of claim 1, wherein the straw is hermetically arranged through the support pad via sealing a flexible film respectively to the support pad and the straw, the flexible film enclosing a volume that includes the second opening of the support pad and a straw portion over the second opening of the support pad.

5. The liquid container of claim 4, wherein the second opening of the support pad is larger than a diameter of the straw.

6. The liquid container of claim 5, wherein a groove is further formed through a lateral side of the straw portion that is located within the volume enclosed by the flexible film, thereby the enclosed liquid is poured out through the straw by turning the liquid container upside-down.

7. The liquid container of claim 1, wherein a tube is further placed through the support pad with a length as short as possible to pour out the entire enclosed liquid.

8. The liquid container of claim 1, further accommodated to a liquid container of gable-top type or flat-top type.

9. The liquid container of claim 2, wherein the support pad is a hollow support pad that respectively includes an upper collar attached to the first opening of the liquid container and through which is defined a third opening that is not sealed, and a lower hollow portion communicating only with the third opening within the liquid container, the lower hollow portion entirely containing an upper portion of the straw folded by means of the elbow portion.

10. The liquid container of claim 2, wherein the support pad includes a recessed cavity at an upper side that confines an upper portion of the straw being folded by means of the elbow portion.

11. The liquid container of claim 10, wherein the recessed cavity is covered and closed by means of a covering that either adheres on the support pad or latches to the support pad.

12. The liquid container of claim 2, wherein the straw support includes a flexible film that attaches the support pad to a rim of the first opening of the liquid container so that the support pad and the straw being folded are contained within the liquid container.

13. The liquid container of claim 1, wherein an upward end of the straw is hermetically closed via a seal.

14. The liquid container of claim 1, wherein the length of the straw substantially reaches a bottom of the liquid container.

15. A liquid container with an intra-packaging straw, comprising:
a liquid container for enclosing a liquid therein, the liquid container having a top portion where a first opening is defined; and
a straw support including a straw, the straw support being hermetically attached into the first opening of the liquid container in such a manner that the straw oppositely extends inside the liquid container and outside the liquid container to allow a user to suck out the enclosed liquid via suction through the straw.

16. The liquid container of claim 15, further accommodated to a liquid container of gable-top type or flat-top type.

17. The liquid container of claim 15, wherein the straw support further comprises a tube that is placed in a manner to oppositely extend toward the interior of the liquid container and the exterior of the liquid container, thereby allowing pouring out of the enclosed liquid.

18. The liquid container of claim 15, wherein the straw further includes an elbow portion.

19. The liquid container of claim 15, further comprising a cover attached onto the liquid container in a manner to enable an enclosure of the straw support.

20. The liquid container of claim 18, wherein the straw support defines an inner hollow volume in which the straw once folded by means of the elbow portion is contained, thereby allowing an arrangement of the straw in a manner not to protrude upwardly out of the straw support.
